(19) United States
(12) Patent Application Publication
(10) Pub. No.: US 2002/0141385 A1
(43) Pub. Date: Oct. 3, 2002

(54) Wireless local area network internet access system

(75) Inventors: Michael S. Wasik, Louisville, CO (US); Todd Jones, Louisville, CO (US)

Correspondence Address: YOUNG & THOMPSON, 745 SOUTH 23RD STREET 2ND FLOOR, ARLINGTON, VA, 22202

(73) Assignee: TRG, Inc.

(21) Appl. No.: 09/819,826

(22) Filed: Mar. 29, 2001

(51) Int. Cl. H04L 12/66

(52) U.S. Cl. 370/352; 370/401

(57) ABSTRACT

An Internet access system includes a wireless local area network having wireless access points and a rental control station connected to the wireless local area network, the rental control station including a network access script generator for generating a network access script, a network access database, and a data input unit, and a wireless station adapter synchronizable to communicate with the access point after having been automatically installed and configured in a communication device by the network access script.

### BACKGROUND OF THE PRESENT INVENTION

Generally, the present invention relates to a wireless local area network Internet access system providing travelers with ad hoc Internet access.

More specifically, the present invention relates to a system and method for travelers conveniently accessing the Internet through a wireless local area network. The wireless local area network includes a rental station having a network access script generator for generating a network access script, a network access database, and a data input unit. The network access script is used to automatically install a wireless station adapter in a communication device, to synchronize the wireless station adapter to an access point of wireless local area network and to provide Internet access including bandwidth assignment.

### . DESCRIPTION OF THE RELATED ART

As the Internet has grown in popularity, both business and non-business users have come to desire, and indeed required, convenient and high-speed Internet access.

Non-business users, e.g., home users, typically connect to the Internet through dial-up modem connections, digital subscriber line (“DSL”) connections, or cable-modem connections. A high skill level is required for successfully installing and configuring equipment necessary to make DSL connections and cable-modem connections. A lower level of skill is required for dial-up modem connections; however, the process none-the-less challenges most users as device drivers, system software, and Internet service provider (“ISP”) protocols must be coordinated.

Businesses face similar problems, but rely on computer technician support for system installation and maintenance. In addition to the above-mentioned means for connecting to the Internet, businesses may provide multiple users with Internet access via a network. OBENHUBER et al. U.S. Pat. No. 6,144,638 discloses one such system. Such systems require computer technician support for adding users to the network. Further, such systems have issues concerning access speed, as well as security issues concerning monitoring and controlling individual users.

When persons travel, they continue to have a need to access the Internet and typically travel with a notebook computer. Public access terminals have been proposed as a means for allowing individual users access to the Internet. SOKAL et al. U.S Pat. No. 5,953,504 discloses one such system.

Such systems, however, do not meet all of the traveler's needs. For example, when using a public access terminal, the traveler does not have access to her own notebook's files and programs. Transferring files to a computer-readable medium, e.g., a diskette, is not convenient and may raise issues of file compatibility with the public access terminal programs. Further, working at a fixed-location public terminal may not let the traveler work with a high-speed connection, conveniently and may not offer an adequate degree of privacy.

Although mini-browser access through cell phones provides a traveler with limited Internet access, such access is likely to be slow, costly, time consuming due to the limited keyboard, and inadequate due to the cell phone lacking true computer capabilities.

Further, when using cell phones to connect with the Internet, there are issues concerning local cell zones and remote cell zones. Some of these issues have been addressed by STEWART U.S. Pat. Nos. 5,835,061 and 5,969,678. However, the disclosed systems require advance planning, coordination, and registration with a nationwide service cell phone/Internet provider. Such systems may also suffer from reception interference so that connections may be interrupted.

### OBJECTS OF THE INVENTION

An object of the present invention is to overcome some of the disadvantages of the prior art systems by providing travelers with a high speed, easy to use, ad hoc wireless local area network Internet access system.

It is a further object of the present invention to provide a novel method of accessing the Internet that avoids interacting with complicated operating system wizards and subsequent system reboots.

It is yet a further object of the present invention to provide a novel method of renting equipment and Internet access to travelers and providing an interface with a local management and accounting system.

It is still a further object of the present invention to provide a novel Internet access system utilizing a wireless local area network with wireless access points and a rental control station. The rental control station is connected to the wireless local area network and through a network access script generator provides a network access script to automatically install a wireless station adapter in a traveler's notebook computer and then to synchronize the wireless station adapter to an access point of wireless local area network so that connectivity to the Internet is provided.

It is another object of the present invention to provide a novel, non-technical system adapted for setting up Internet access and access equipment rental where neither the system operators nor the traveler-users need exercise technical setup skills.

It is yet a further object of the present invention to provide an Internet access and rental system a capability to operate throughout plural wireless access zones.

It is yet another object of the present invention to provide a novel Internet access system that individually monitors each user accessing the Internet through the access system.

It is a still further object of the present invention to provide a novel system of controlling access system security by providing users with revisable access codes keyed access codes corresponding to particular system access points, the access codes being subject to remote individual change, change based on code age, and change based on calendar date.

These and other objects and advantages of the present invention will be apparent to those of skill in the art from a perusal hereof.

### SUMMARY OF THE INVENTION

The invention provides a method and system for travelers to easily access the Internet on an ad hoc basis.

The inventive Internet access system includes a wireless local area network with at least one wireless access point and a rental control station. The rental control station may be a personal computer, optionally including a network access script generator, a network access database, and a data input unit. As an alternative to a script generator, the rental station may include pre-generated script files installed on CD-ROM disks. To connect a traveler's notebook or other communication device to the wireless local area network, and thereby to the Internet, the invention includes a wireless station adapter synchronizable with the access point.

Advantageously, the network access script generator provides an access script that automatically installs and configures the wireless station adapter into the traveler's notebook. Wireless station adapters include PCMCIA wireless network cards or may be integrated into the user's notebook. Using wireless station adapters, access to the Internet can be 50 to 100 times faster than a dial-up connection.

The Internet access system may comprise a wireless local area network, such as IEEE 802.11, 802.11a, and 802.11b networks. The inventive system may have plural wireless access points located throughout a building or facility such as a hotel, an airport, college campuses, or hospitality site with out-of-doors locations. In this way, travelers are free to access the Internet from any convenient location and at a high baud rate.

IEEE 802.11, using the 2.4 GHz band, provides bandwidth at a maximum rate of 2 Mbps. Using IEEE 802.11b High Rate (Wi-Fi), increases the maximum transfer rate to 11 Mbps.

The invention allows for many users to simultaneously access the Internet through the wireless local area network. Conveniently, the inventive system may include plural station adapters, each station adapter being individually addressable from the rental control station via an access point. The station adapters may be synchronized with the access point in a predefined constant frequency, or may be synchronized with the access point by frequency hopping.

The inventive system may use the unlicensed frequency between 2.4 and 2.5 Ghz. Frequency hopping across the entire wireless network frequency ban promotes high confidentiality of transmitted information. Frequency hopping also increases the user capacity of this limited frequency range. A still further advantage of frequency hopping is that such a connection better withstands interference.

Using an IEEE 802.11 standard network permits network adaptor cards using infrared, as well as Frequency Hopping Spread Spectrum (FHSS) and Direct Sequence Spread Spectrum (DSSS) radio signals.

FHSS provides 1-MHz channels and a data transfer rate of up to 2 Mbps. DSSS provides partially-overlapping 22-MHz channels. Using chipping, DSSS spreads modulated data across the 22-Mhz channel. DSSS with standard Barker code generates a Binary or Quadrature Phase Shift Keying modulated carrier wave. A maximum transfer rate similar to FHSS results.

802.11b, using DSSS together with Complementary Code Keying, provides a maximum transfer rate of 11 Mbps.

The invention also is suitable for operation in unlicensed 100 MHz sub-bands in the 5 GHz regions.

Advantageously, the invention is adaptable to new standards such as IEEE 802.11a. Under developing standards, wireless speeds of 54 Mbps may be attained.

The present invention also supports Dynamic Host Configuration Protocols (“DHCP”), e.g., to assign and to renew IP address information at the traveler's notebook computer.

The invention promotes network security.

The invention provides access security through the use of Extended Service Set Ids (“ESSIDs”). Notably, the access script file configures each station adapter with an Extended Service Set ID matching with an Extended Service Set ID associated with an access point. Control within a facility can be provided by assigning different ESSIDs to different access points and limiting a station adapter to be configured with only selected ESSIDs corresponding to areas corresponding to selected access points.

Both security and accounting functions are enhanced by the rental station including a module for updating a network access database with assigned ESSIDs and information identifying the wireless PCMCIA network card assigned to each traveler-user. Security and accounting are also enhanced by the access script file comprising a time module to alter an ESSID assigned to a particular network adapter after a programmed period of time, after an ESSID expiration date. In this way, if a traveler only needs Internet access for the first day of a three-day visit, the rental control station generates an access script that changes or erases the assigned ESSID after the first day. The traveler thus only pays for the period of anticipated use and need not immediately return the network adapter. Similarly, the access script file may change the ESSID as a function of a calendar date and time.

After the network adapter has had the ESSID changed or erased, synchronization with the wireless local area network and therefore access to the Internet is lost. However, in the case where the ESSID is changed and not erased, as the network can communicate with the network adapters individually, an access point can be changed to a matching ESSID and re-assign an ESSID to the “de-activated” network adapter so as to re-activate the network adapter.

Alternatively, security can be maintained with encryption, e.g., Wired Equivalent Privacy (WEP) encryption. Encryption is with multibit shared keys, e.g., 40- or 128 bit shared keys. Using public key cryptology, the invention generates session keys to avoid the use of ESSIDs. The traveler and assess point exchange a challenge/response encrypted message with the same crypto key.

The invention also includes a feature whereby the inventive rental system includes Internet access-configurable portable computers, e.g., a portable computer with a PCMCIA port or integrated wireless adapter. The rental station operator assigns the user with a notebook, one of the access system's wireless PCMCIA network cards may be inserted in the PCMCIA port, and a computer diskette or CD-ROM containing a wireless network access script. The access script includes a code module for automatically assigning to the wireless PCMCIA network card at least one ESSID matching with an access point ESSID, and an automated device driver for configuring the wireless PCMCIA network card to the portable computer.

The rental control station, through the network access database and communications with the individual network adapters, monitors inventory by tracking network adapters in use, monitors individual access times, and may computer billing charges based on access time.

### BRIEF DESCRIPTION OF THE DRAWINGS

FIG. 1 is a view of a first embodiment of the inventive Internet access system of the present invention.

FIG. 2 schematically shows the rental control station and access script of the invention.

FIG. 3 is a flow chart illustrating the inventive system.

### DESCRIPTION OF PREFERRED EMBODIMENTS

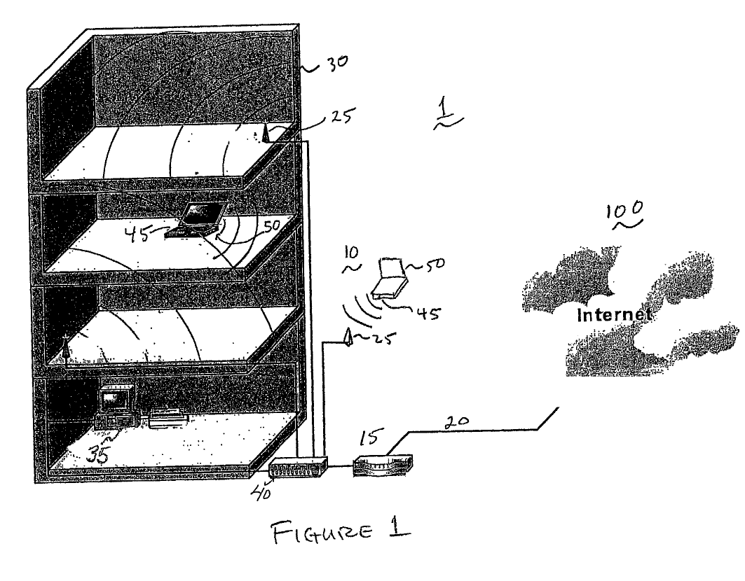

With reference to FIG. 1, a first embodiment of the present inventive system 1 includes a wireless local area network 10 connected to the Internet 100. The wireless local area network 10 may be connected to the Internet 100 via a connecting device such as router 15 and a high-speed line 20.

The wireless local area network includes at least one wireless access point 25, normally located in a building 30. However, the wireless local area network may include plural access points, which access points may be interior to the building and exterior to the building.

A rental control station 35 (or rental station) is located within the building 30 and is connected to the wireless local area network 10 by any convenient technique. As discussed above, the network itself may be of any suitable type, e.g., Ethernet in a star configuration with a central switch 40. The rental control station 35 may be a personal computer or minicomputer. The rental control station 35 may be linked to a facility computer so as to either off-load management and accounting functions to the facility computer or to co-ordinate with the facility computer by data transfers.

The rental control station 35 accepts information concerning a user, e.g., a user's room number, and generates a network access script 110, which script in turn configures the user's notebook computer 45 for an assigned wireless network adapter 50, to bind the TCP/IP protocol, and to render the wireless network adapter 50 as a network and Internet access device for the user's computer 45. When a CD-ROM with a predetermined script is used, a packet code is entered into the rental control station 35, the rental control station in turn generates a password that activates the wireless adaptor on the network, where the password is unique to the script found on that CD-ROM.

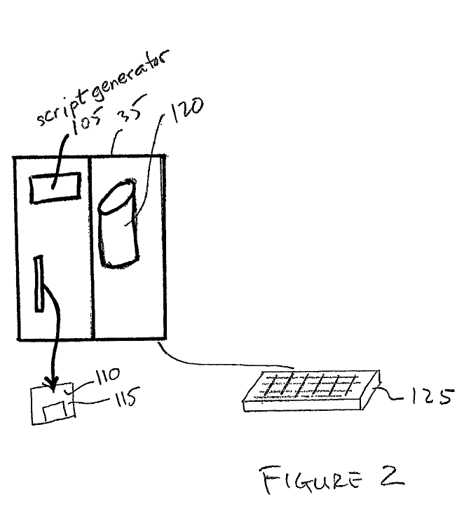

Referring to FIG. 2, the rental control station 35 includes a network access script generator 105 for generating a network access script 110 recorded on a computer-readable medium 115. The computer-readable medium may be of any convenient form such as CDROM, diskette, smart card, and memory within a PCMCIA wireless network adapter 50. The script generator 105 may be computer code suitably stored or encoded on the rental control station 35.

The rental control station 35 also includes a network access database 120 and a data input unit 125, e.g., a keyboard, mouse, input pad. The rental control station operator uses the data input unit 125 to enter into the rental control station 35 and the network access database, information that uniquely identifies the user, optionally the traveler-user's computer 45, and the to-be-assigned network adapter card 50, as well as appropriate accounting information.

With this information, the network access script generator 105 creates an access script 110 and records the script on the computer-readable medium 115 of choice.

Upon insertion of the computer-readable medium 115 into the traveler-user's notebook 45, the network access script 110 executes to automatically install the drivers for wireless station adapter 50 in the traveler-user's notebook 45 to configure the wireless station adapter 50 for synchronization with an access point 25 by adding to the notebook 45 necessary registry keys to successfully bind TCP/IP to the wireless station adapter when the adapter is subsequently inserted.

Upon subsequent insertion of the station adapter, the operating system pings the Internet gateway, synchronizing with an access point 25, and automatically launches an Internet browser to complete access to the Internet 100.

The network access script 110 synchronizes the station adapter 50 with the access point 25. Access may be, for example, at either a predefined constant frequency, by frequency hopping, or by DSSS.

The access script 110 configures the station adapter 45 with an Extended Service Set ID matching with an access point Extended Service Set ID associated with the access point. Unless the traveler-user's station adapter 45 includes an ESSID that matches the access point's ESSID, the traveler-user's notebook 50 is not allowed to join or synchronize with the access point 25 and local area network 10.

By requiring matching ESSIDs between the station adapter 45 and the access point 25, persons with station adapters tuned to an otherwise acceptable predefined frequency scheme remain barred from joining or synchronizing with the local area network. In this way system security is enhanced and theft of system services is prevented.

As an alternative to using ESSIDs, the invention supports public key cryptology wherein the wireless adapter and the access point exchange a challenge/response encrypted message with the same crypto key in order to establish synchronization.

As the rental station controls the ESSIDs, or crypto key, and is in communication with both the access points and the users' notebook computers, the rental station can change ESSIDs, or crypto keys, as necessary to control network, and Internet, access. Any change of ESSIDs or crypto keys would be recorded on the network access database. This approach ensures that the network access database can reliably track station adapter (user) use of the network and Internet as well as bandwidth usage.

System security is also enhanced using the rental control station 35 to monitor each of the plural network station adapters 45 assigned to traveler-users and configured in traveler-users' notebooks 50. The rental control station 35 can communicate individually with each network station adapter, via the wireless network 10 and an access point 25.

Upon synchronization with the network, the system may optionally assign bandwidth to the user's notebook. The assigned bandwidth is recorded in the database 120 for accounting and other purposes.

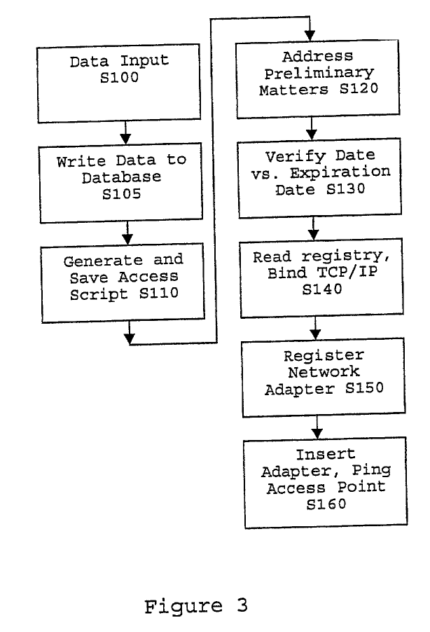

Referring to FIG. 3, there is shown both server-side (rental control station) and client-side (user's notebook 45) activity.

The programming portions of the invention may be implemented in any convenient language and structure. One embodiment utilizes Microsoft™ Access database software with templates for collecting information and providing information to the script generator 105.

The script may be a Word™ document with fixed code and markers where unique information is inserted. Advantageously, the script need vary only as to the unique information such as ESSIDs, crypto keys, dates and passwords.

At the rental control station 35, the operator enters data (at S100) relating to the user and the equipment. For example, the data may include a user's name and room number or, in the case of a pre-programmed CD-ROM, a password. The data is written to database 120 (at S105).

The script generator 105 creates a password and, together with the current date, creates a new script for the user. The script may be encrypted.

Necessary system files, including driver files are recorded on a suitable computer-readable medium, e.g., a diskette (at S110).

The user is given the diskette with the network access script S110 and necessary ancillary files. At step S120 the user need only insert the diskette into the user's notebook. The script, upon execution, initially attends to various preliminary matters.

The preliminary matters include:

1) creating new directories and sub-directories for the files associated with the wireless network adapter and necessary for modifying the computer's operating system;

2) copying system verifying code, driver files, a date file, and support files onto the user's computer in the newly created directories and the system operating directories;

3) backing up the user's computer's registry;

4) verifying that the user's computer currently includes necessary compatible scripting components, installing such components if needed; and

5) examining the registry for keys necessary to decode any pre-existing encrypted files, and adding necessary keys to support de-encryption.

At step S130, and each time the user's computer is booted, the script directs that a date-verification be completed. The date file, loaded in step S120, includes an ESSID expiration date, typically step for some fixed period, e.g., 20 days from checkout of the system equipment, as discussed above to discourage theft of equipment and services.

If the present date is beyond the ESSID expiration date, the script setup operation halts and the user is prompted to renew the access script at the rental control station.

At step S140, the ESSID expiration date is set into an operating system directory for future reference and control. The script next invokes a registry key inspection which identifies existing protocol stack components and determines the necessary registry keys to be added in order to successfully bind TCP/IP protocol to the wireless network adapter

After the inspection and determination are complete, the script writes the necessary registry keys and copies appropriate adapter devices onto the user's computer. At this point, at least one ESSID (or crypto key) is set by writing to a registry file. Upon successfully copying the necessary files, at step S150, the script silently registers the network adapter's device driver files with the operating system registry.

This approach of the invention advantageously avoids any interaction with, or any invocation of, operating system wizards. Avoiding the use of wizards simplifies the configuration process and enhances the user's experience, as the user is not subjected to responding to wizard prompts. Further, no rebooting of the computer is required, again enhancing the user's experience.

The network adapter having been registered with the operating system, at step S160, the user is prompted to insert the network adapter itself into the computer. Upon the computer sensing insertion of the network adapter, the adapter is instructed to ping the network gateway and thereafter automatically launch the default Internet browser.

As noted above, upon each boot of the user's computer, step S130 is invoked to verify the current date is not beyond the ESSID expiration date. If the current date is beyond the expiration date, the user is prompted to renew (check out again) the network access script and network adapter. At this time, the files previously loaded onto the user's computer may, optionally, be erased and the system registry restored. Alternatively, the ESSID may be erased or changed to an ESSID having limited network and Internet access.

In one embodiment, the script makes the gateway address, DNS server, and IP address assignment to the wireless adapter. In another embodiment, when the wireless adapter connects to the access point, it is subsequently connected to a network segment where DHCP is active. DHCP assigns the gateway address, DNS server, and IP address assignments to the wireless adapter.

What is claimed is:

1. An Internet access system, comprising;
a wireless local area network having a wireless access point located in a building and connected to the Internet;
a rental station located within the building and connected to the wireless local area network,
the rental station including a network access script generator for generating a network access script, and a network access database, and a data input unit,
the network access script generator operatively connected to the network access database and the data input unit; and
a wireless station adapter synchronizable to communicate with the access point after having been installed and configured in a communication device,
wherein the network access script from the network access script generator operates to automatically install the wireless station adapter in the communication device and to configure the wireless station adapter for synchronization with the access point.

2. The system of claim 1, wherein the wireless local area network is an Ethernet network, the station adapter is a wireless PCMCIA network card, the communication device is a personal computer, and the network access script generator writes the network access script file on a computer-readable medium.

3. The system of claim 2, wherein the system comprises plural station adapters, each station adapter individually addressable from the rental station via the access point.

4. The system of claim 1, wherein the script file reads operating system registry keys to identify existing protocol stack components of the communication device and determine registry keys necessary for binding TCP/IP to the station adapter.

5. The system of claim 4, wherein the station adapter is configured free from interaction with any operating system wizard and any operating system reboot.

6. The system of claim 3, wherein the access script file configures the station adapter with a first Extended Service Set ID matching with an access point Extended Service Set ID associated with the access point.

7. The system of claim 6, wherein the rental station further comprises a module for assigning the access point with the access point Extended Service Set ID.

8. The system of claim 6, wherein the rental station comprises a module for updating the network access database with the first Extended Service Set ID and information identifying the wireless PCMCIA network card.

9. The system of claim 6, wherein the access script file comprises a time module to alter the first Extended Service Set ID as a function of elapsed time.

10. The system of claim 6, wherein the access script file comprises a Extended Service Set ID change module for changing the first Extended Service Set ID as a function of a calendar date.

11. The system of claim 2, wherein the access script file includes an encryption key for matching with an access point encryption key associated with the access point.

12. The system of claim 6, wherein the access point Extended Service Set ID can be changed by wireless communication with the wireless PCMCIA network card via the access point.

13. The system of claim 2, wherein the system further comprises wireless access points outside the building, the wireless local area network further comprises plural wireless access points within the building, and the access script file provides the wireless PCMCIA network card with plural Extended Service Set IDs matching with plural access point Extended Service Set IDs associated with plural wireless access points.

14. An Internet access-configurable portable computing device, comprising:
a portable computing device including a wireless network adapter; and
a portable computer-readable medium containing a wireless network access script, the access script including a code for automatically synchronizing the wireless network adapter with a wireless network access point.

15. The computing device of claim 14, wherein the access script comprises a time module to alter the code as a function of elapsed time.

16. The computing device of claim 14, wherein the computer-readable medium is a CD-ROM and the code is an encryption code.

17. An Internet access system, comprising;
a wireless local area network having plural wireless access points distributed throughout a facility,
a Internet connecting device connecting the wireless local area network to the Internet;
a rental station located within the facility and connected to the wireless local area network; and
a wireless station adapter synchronizable with the access points upon installation and configuration in a portable computer;
the rental station including a network access script generator for generating a network access script with modules for automatically installing and configuring the station adapter for synchronization with the access points.

18. The system of claim 17, wherein the rental station is configured to assign Extended Service Set IDs to the wireless station adapter matching selected ones of the plural wireless access points as a condition for synchronization between the wireless station adapter and the wireless access points.

19. The system of claim 18, wherein the rental station further comprises a database tracking wireless station adapter use and assignment of bandwidth of to the wireless station adapter and the portable computer.

20. The system of claim 18, wherein,
the network access script includes a time-limit code written for limiting an amount of time the wireless station adapter maintains an Extended Service Set ID assignment, after which time the time-limit code removes the assigned Extended Service Set ID from the wireless station adapter, and
the network access script accesses registry keys in the portable computer for determining existing protocol stack components on the portable computer and binding TCP/IP to the wireless station adapter, configuring the portable computer for network and Internet access free from interaction with an operating system wizard and an operating system reboot.
